(19) United States
(12) Patent Application Publication
(10) Pub. No.: US 2025/0100409 A1
(43) Pub. Date: Mar. 27, 2025

(54) SYSTEMS AND METHOD FOR CHARGING ELECTRIC VEHICLES WITHOUT ACCESS TO THE POWER GRID

(71) Applicant: BC Energy, LLC, Colusa, CA (US)

(72) Inventor: Carrie A. Schmidt Poyner, Colusa, CA (US)

(21) Appl. No.: 18/896,305

(22) Filed: Sep. 25, 2024

Related U.S. Application Data
(60) Provisional application No. 63/585,203, filed on Sep. 25, 2023.
(60) Provisional application No. 63/685,099, filed on Aug. 20, 2024.

(51) Int. Cl. B60L 53/30; B60L 53/18; B60L 53/51; B60L 53/53; B60L 53/57; E01F 15/14; E04H 1/12; H02J 7/35; H02S 10/40; H02S 20/23

(52) U.S. Cl. CPC B60L 53/30; B60L 53/18; B60L 53/51; B60L 53/53; B60L 53/57; E01F 15/14; E04H 1/1205; H02S 10/40; H02S 20/23; E04H 2001/1283; H02J 7/35

(57) ABSTRACT

A renewable, portable energy system for charging electric vehicles in rural areas that lack access to a traditional power supply may include a modular housing having exterior and interior portions, at least one charging station couplable to the exterior portion, the at least one charging station configured to charge an electric vehicle, a solar array including a plurality of solar panels configured to receive solar energy, and at least one battery storage device positioned within the interior portion. The at least one battery storage device can be electrically couplable to the solar array and can be configured to receive and store solar energy from the solar array. The at least one battery storage device can be electrically couplable to the at least one charging station and can be configured to transfer the solar energy to the at least one charging station for use in charging an electric vehicle.

### CROSS-REFERENCE TO RELATED APPLICATIONS

The present application claims the benefit of U.S. Provisional Application No. 63/585,203, filed Sep. 25, 2023 and U.S. Provisional Application No. 63/685,099, filed Aug. 20, 2024, the complete disclosures of which are incorporated by reference in their entireties.

### FIELD OF INVENTION

The present disclosure relates to systems and methods for charging electric vehicles, in particular, the charging of electric vehicles in locations without access or connection to the power grid.

### BACKGROUND

In recent years, the popularity of electric vehicles has risen significantly. This phenomenon is driven by a host of factors, including increased concern about pollution caused by gas-powered vehicles, unpredictable oil prices and supply, and energy independence.

Electric vehicles require charging periodically, depending on the range of the vehicle. In urban environments, electric vehicle owners may install an electric vehicle charger in their homes. Alternatively, electric vehicle chargers have been installed in various locations in public, where electric vehicle owners can charge the vehicles for a fee.

The installation of these chargers require compatibility with existing infrastructure. To supply energy to charging electric vehicles, the chargers are connected to existing power grids. While this method of drawing power works well in urban environments, rural or remote regions do not have the same existing infrastructure to draw power from. Accordingly, electric vehicles are not a feasible transportation solution in rural or remote areas that do not have a robust power grid. Further, a lack of available electric chargers on or near rural or remote roads limits electric vehicle owners from traveling through these regions.

There is a demonstrated need for systems and methods for charging electric vehicles in rural and remote areas that do not have access to an existing, robust power grid.

### SUMMARY

The present disclosure addresses the demonstrated need described above, as well as other renewable energy needs that will become apparent throughout this disclosure. Systems and methods described herein relate to charging electric vehicles in rural, remote areas that do not have access to an existing, robust power grid. According to an embodiment of the present disclosure, a system for charging electric vehicles in rural remote areas can include a modular housing, at least one charging station, a plurality of solar panels, and a battery storage device. The modular housing can be fabricated into a variety of sizes and shapes, depending on the location. With the system described in this embodiment, electric vehicle users can charge their vehicles in remote or rural locations that do not have access to the power grid.

In other embodiments, a renewable, portable energy system for charging electric vehicles in rural areas that lack access to a traditional power supply may include a modular housing having an exterior portion and an interior portion, at least one charging station couplable to the exterior portion of the modular housing, the at least one charging station configured to charge an electric vehicle. The system may further include a solar array comprising a plurality of solar panels configured to receive solar energy, and at least one battery storage device positioned within the interior portion of the modular housing. The at least one battery storage device can be electrically couplable to the solar array and can be configured to receive and store solar energy from the solar array. The at least one battery storage device can be electrically couplable to the at least one charging station and can be configured to transfer the solar energy to the at least one charging station for use in charging an electric vehicle.

In embodiments, the modular housing may include a plurality of walls connected to form a rectangular container. In embodiments, the modular housing can further include at least one door separating the exterior portion from the interior portion. In embodiments, the system can further include at least one car bumper guard couplable to the exterior portion of the modular housing, the at least one car bumper guard configured to prevent parking vehicles from striking the exterior portion. In embodiments, the modular housing can be insulated to create a temperature-controlled environment within the interior portion. In embodiments, the at least one battery storage device can be couplable to a cabinet mounted within the interior portion.

In embodiments, the system may further include a mount apparatus couplable on one end to the modular housing and on another end to the solar array, the mount apparatus configured to support the solar array on top of the modular housing. In embodiments, the at least one charging station may include an electric vehicle charger, a retractable charging cord couplable to the charger, and a charging holder for storing the charger and the charging cord when not in use. In embodiments, the system may further include a remote-controlled HVAC unit positioned within the interior portion of the modular housing. In embodiments, the modular housing, the at least one charging station, the solar array, and the at least one battery storage device can be configured for uninterrupted, continuous use for long periods of time when assembled and put into operation in a rural area.

In embodiments, a renewable, portable energy system for charging electric vehicles in rural areas that lack access to a traditional power supply may include a modular housing having an exterior portion and an interior portion, the modular housing including a plurality of walls connected to form a rectangular container. The system may further include at least one charging station couplable to the exterior portion of the modular housing, the at least one charging station configured to charge an electric vehicle. The system may further include a solar array including a plurality of solar panels configured to receive solar energy, the solar array being couplable to the modular housing via a mount apparatus. The system may further include at least one battery storage device positioned within the interior portion of the modular housing. The at least one battery storage device can be electrically couplable to the solar array and can be configured to receive and store solar energy from the solar array. The at least one battery storage device can be electrically couplable to the at least one charging station and can be configured to transfer the solar energy to the at least one charging station for use in charging an electric vehicle. The modular housing, the at least one charging station, the solar array, and the at least one battery storage device can be configured for uninterrupted, continuous use for long periods of time when assembled and put into operation in a rural area.

In embodiments, the modular housing may further include at least one door separating the exterior portion from the interior portion, the at least one door being couplable to the modular housing via a hinge. In embodiments, the system may further include at least one car bumper guard couplable to the exterior portion of the modular housing, the at least one car bumper guard configured to prevent parking vehicles from striking the exterior portion. The car bumper guard can define a semi-circle shape, such that the end points of the semi-circle are affixed to the exterior portion of the modular housing. In embodiments, the modular housing can be insulated to create a temperature-controlled environment within the interior portion, such that the interior portion is insulated from harsh external weather conditions at the rural area.

In embodiments, the at least one battery storage device can be couplable to a cabinet mounted within the interior portion. In embodiments, the at least one charging station may include an electric vehicle charger, a retractable charging cord coupled to the charger, and a charging holder for storing the charger and the charging cord when not in use. In embodiments, the system may further include a remote-controlled HVAC unit positioned within the interior portion of the modular housing, the HVAC unit configured to maintain a temperature-controlled environment within the interior portion to preserve operation of the at least one battery storage device. In embodiments, the system may further include at least one Internet-of-things device communicatively couplable to a remote device external to the system. In embodiments, the system may further include one or more of a general load panel, a solar panel control unit, and a combiner panel positioned within the interior portion of the modular housing.

In embodiments, a method of assembling a renewable, modular energy system for use in rural areas that lack access to a traditional power supply may include staging and sizing materials for future assembly of the modular energy system having a geometric footprint compatible with an intended use location in a rural area lacking access to a reliable power grid. The method may further include fabricating the modular energy system comprising a modular housing, a solar array having a plurality of solar panels, and at least one charging station, wherein the solar array is electrically couplable to the at least one charging station to enable electric vehicle charging using solar energy. The method may further include assembling an interior electrical system of the modular energy system including at least one battery storage device configured to storage solar energy obtained by the solar array. The method may further include affixing the solar array and the at least one charging station to an exterior portion of the modular housing. The method may further include disassembling a completed modular energy system in preparation for transportation to the intended use location. The method may further include assembling and activating the modular energy system at the intended use location.

The summary above is not intended to describe each illustrated embodiment or every implementation of the present disclosure. The figures and the detailed description that follow more particularly exemplify these embodiments.

### BRIEF DESCRIPTION OF THE DRAWING

Subject matter hereof may be more thoroughly understood in consideration of the following detailed description of various embodiments in connection with the accompanying figures, in which:

FIG. 1 depicts a perspective view of a system for charging electric vehicles, according to embodiments of the present disclosure.

FIG. 2A depicts a top view of the system for charging electric vehicles of FIG. 1, according to embodiments of the present disclosure.

FIG. 2B depicts a cutaway top view of the system for charging electric vehicles of FIG. 1, according to embodiments of the present disclosure.

FIGS. 2C and 2D depict front and rear views, respectively, of the system for charging electric vehicles of FIG. 1, according to embodiments of the present disclosure.

FIGS. 2E and 2F depict left and right side views, respectively, of the system for charging electric vehicles of FIG. 1, according to embodiments of the present disclosure.

FIG. 2G depicts a bottom view of the system for charging electric vehicles of FIG. 1, according to embodiments of the present disclosure.

FIG. 2H depicts a cutaway rear view of the system for charging electric vehicles of FIG. 1, according to embodiments of the present disclosure.

FIGS. 3A and 3B depict perspective views of an interior region of a system for charging electric vehicles, according to embodiments of the present disclosure.

FIG. 4 depicts an electrical schematic used with a system for charging electric vehicles, according to embodiments of the present disclosure.

FIG. 5 depicts a block diagram of electrical equipment used with a system for charging electric vehicles, according to embodiments of the present disclosure.

FIG. 6 depicts a method of assembling a modular energy system for charging electric vehicles, according to embodiments of the present disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter of the present disclosure.

### DETAILED DESCRIPTION

Current electric vehicle charging stations are limited in location by proximity to the power grid. Systems and methods for charging electric vehicles that do not have access to a power grid addresses this problem. In an embodiment, a system for charging an electric vehicle that does not have access to a power grid can comprise a modular housing, at least one charging station, a plurality of solar panels, and at least one battery storage device. No further engineering, construction, or utility connections are required after fabrication of the system described in this embodiment.

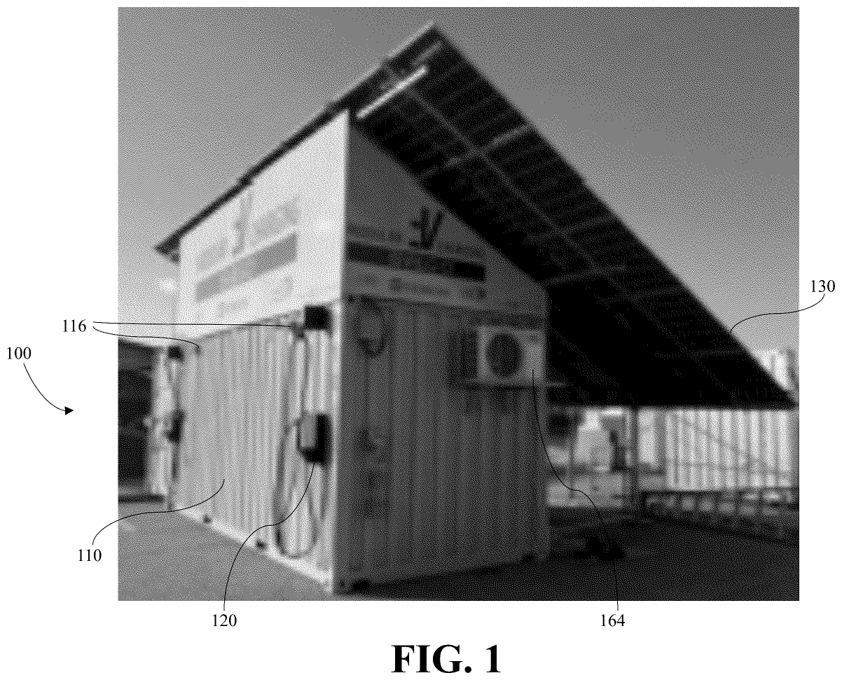

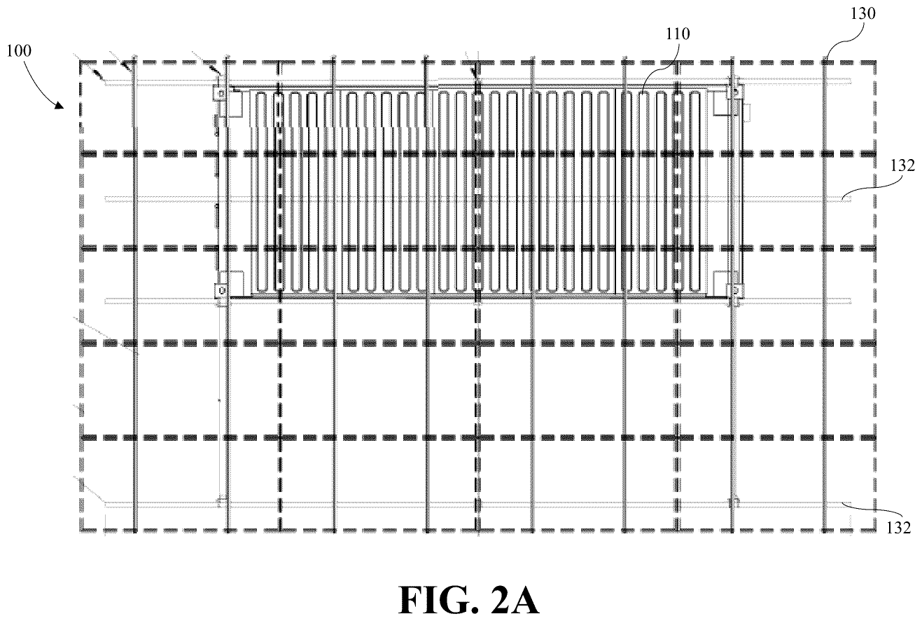

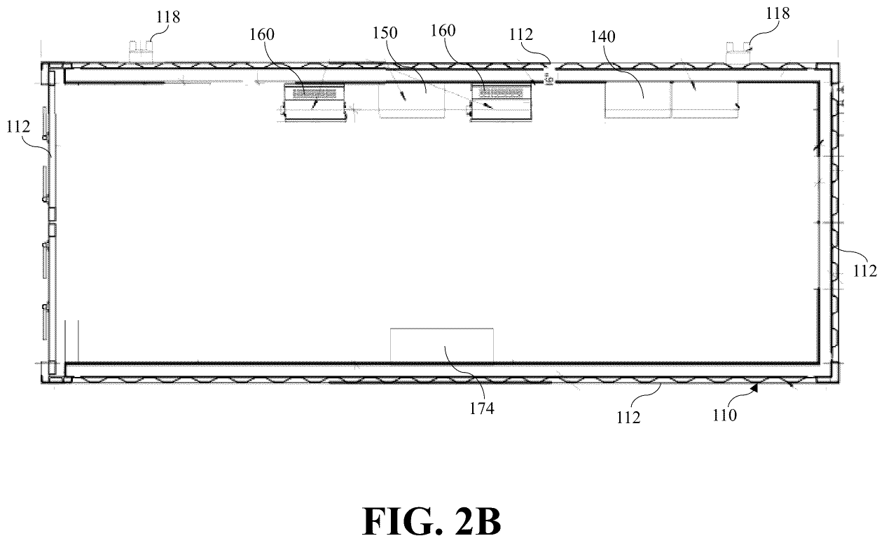

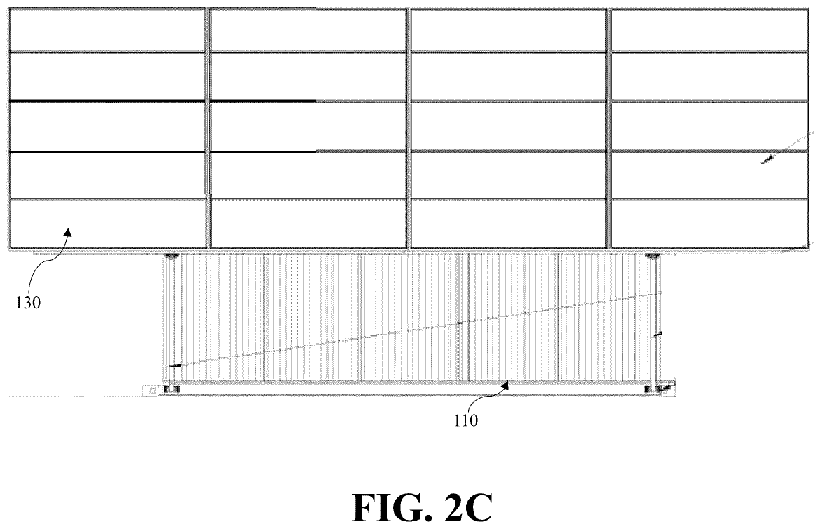

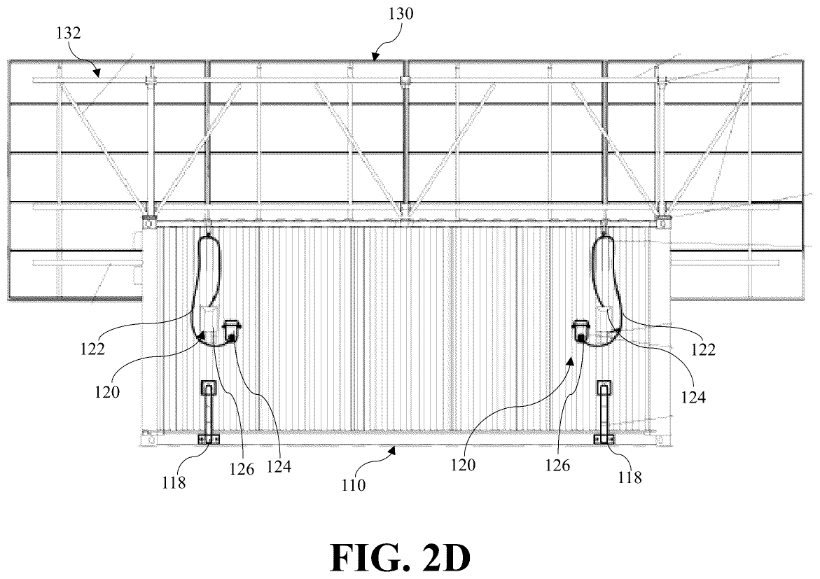

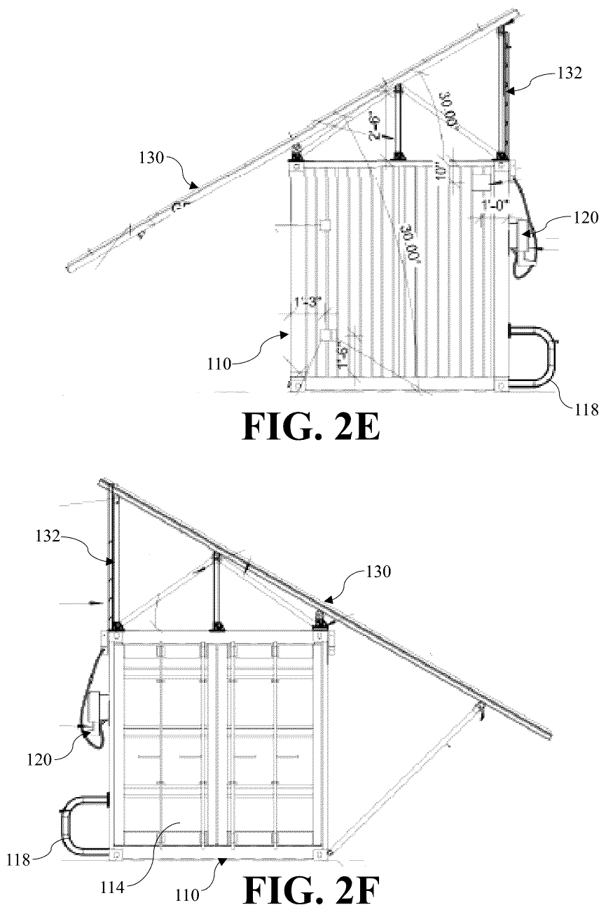

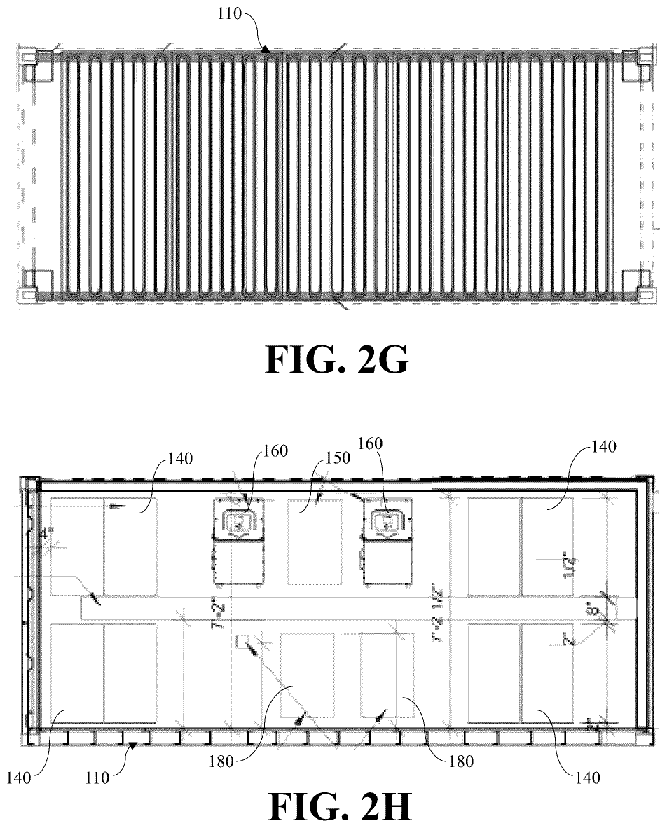

Embodiments directed to such systems are depicted throughout the figures and will now be described in greater detail. Referring generally to FIGS. 1-2H, a system 100 for charging electric vehicles may comprise a modular housing 110, at least one charging station 120, a plurality of solar panels 130, at least one battery storage device 140, at least one general load panel 150, and at least one solar panel unit 160. System 100 is configured for use in rural or remote areas where access to a power grid is unavailable or difficult to acquire. Moreover, system 100 is configured to be resistant to various weather and climatic conditions common around the world. System 100 is also configured to be resistant to vandalism and other harms caused by humans by incorporating various security features such as electrical dashboard monitoring, security lighting, strong materials, and cameras or other recording devices. This ensures that system 100 is capable of reliable and long-lasting use in rural or remote areas where repair systems and reliable modes of communication are typically unavailable.

Modular housing 110 can comprise a variety of footprints, including but not limited to a rectangular footprint, similar to that of a shipping container, wherein one side of the modular housing 110 can comprise at least one door 114 on hinges. In such an embodiment, modular housing 110 may include a plurality of walls 112 all connected to form an integral structure, with a door 114 couplable to an opening in one of the plurality of walls 112. The footprint of the modular housing 110 can be varied depending on the intended location of use and desired size of system 100. The plurality of walls 112 of the modular housing 110 can be constructed from materials known by those of ordinary skill in the art, such as corrugated metal panels. The plurality of walls 112 may further comprise insulation and wall paneling. Modular housing 110 can be further configured to withstand wind loads of approximately 290 kilometers per hour (approximately 180 miles per hour), for example. Modular housing 110 may also be configured to withstand various extreme weather conditions such as low or high temperatures, snow, ice, rain, hail, or lightning, for example. Because modular housing 110 is made from strong materials like corrugated metal panels, it is generally configured to be resistant not only to weather and climatic conditions such as those described previously, but also to human conditions such as vandalism and damage that would normally render system 100 inoperable. This makes modular housing 110 advantageous over conventional electric vehicle charging systems which are not intended for use in rural or remote areas with no or limited access to a reliable power grid.

The modular housing 110 may further comprise several exterior elements, including exterior lighting 116, a 50-amp outlet configured for use with various electronic devices, a car bumper guard 118, and an exterior plug that can accommodate a generator. The exterior lighting 116 may be motion activated, activated by a timer, activated by an electronic device such as a computer, or continuously lit throughout the day. The car bumper guard 118 can be configured to prevent parking vehicles from striking the exterior of the modular housing 110. In embodiments of the present disclosure, the car bumper guard 118 can define a semi-circle shape, such that the end points of the semi-circle are affixed to an exterior wall of the modular housing 110. In embodiments, car bumper guard 118 may be affixed to a position on an exterior wall of modular housing 110 that is underneath or nearby a charging station 120. This configuration provides protection to charging station 120 when a parking vehicle approaches system 100 for charging. It is understood by one of skill in the art that the aforementioned exterior elements are only exemplary and other elements may be suitable.

The modular housing 110 may define an interior space or portion. The interior space of the modular housing 110 can accommodate, for example, the at least one battery storage device 140, at least one light source 170, a dashboard, an HVAC unit 174 with a remote monitor, and a remote Wi-Fi hot spot 176. The light source 170 may be automated, such that the interior is lit when there is motion detected, or activated by a timer, activated by an electronic device, or continuously lit. The light source 170 may alternatively be activated via a manual switch. The dashboard 172 can provide output and input data, such that the status of the various components of system 100 can be monitored in real-time by a user inside the interior space. The HVAC unit 174 with a remote monitor can be configured such that the temperature of system 100 can be monitored and controlled from a remote location, advantageously to protect the integrity of the internal elements from extreme temperatures. Wi-Fi hot spot 176 can be couplable to an interior wall of modular housing 110 and can be configured to provide access to the Internet for users during vehicle charging. This provides convenient and reliable Internet access which typically is unavailable or difficult to acquire in remote or rural areas where system 100 is contemplated for use.

The at least one battery storage device 140 can further comprise an inverter 178, at least one combiner panel 180, and a critical load panel 182. Inverter 178 can be configured to charge battery storage device 140 using surplus energy during times of low solar energy generation, thereby acting as a backup power solution for limited periods of time. The at least one combiner panel 180 can be configured to combine the energy outputs of the plurality of solar panels 130 (e.g., a solar array) into a single, common solar energy source. Critical load panel 182 can be configured to protect the at least one battery storage device 140 from unintended electrical failures due to overuse, while also ensuring that the at least one charging station 120 stays continuously operable. The at least one battery storage device 140 can be configured to be self-contained, such that no inputs or outputs beyond those included with system 100 are required. The battery storage device 140 can be further configured to accommodate a predetermined battery storage reserve. For example, in some embodiments, the at least one battery storage device 140 can be configured to maintain a 72-hour battery storage reserve, for example. This advantageously enables embodiments of the present disclosure to be reliable sources of power in remote locations in instances of extreme weather or natural disaster, or where suitable repair services are unavailable, for example.

The at least one battery storage device 140 can be functionally connected to the at least one charging station 120, configured to supply power to an electric vehicle connected to the at least one charging station 120. The at least one charging station 120 can comprise, for example, the Siemens VersiCharge® Level 2 J1772 charger, or another similar charging station. The at least one charging station 120 can further comprise a retractable charging cord 122, at least long enough in length to reach the charging port of an electric vehicle parked outside of the system 100. The at least one charging station 120 can further comprise a charger 124 configured to connect to an electric vehicle for charging, as understood by one of ordinary skill in the art. The at least one charging station 120 can further comprise a charger holder 126 couplable to an exterior wall of modular housing 110. Charging holder 126 can be configured to store retractable charging cord 122 and charger 124 when these components are not in use. The individual components of an embodiment of the at least one charging station 120 are illustrated particularly in FIGS. 2D-2F.

The at least one battery storage device 140 can also be functionally connected to the plurality of solar panels 130. The plurality of solar panels 130, which could be called a solar array, can be configured to convert 11 kWh of solar energy into the at least one battery storage device 140, for example. The number of solar panels comprising the constructed plurality of solar panels 130 depends on the requirements of the particular embodiment and location of use, and should be scaled depending on the anticipated power demands of the particular use case. In embodiments, the plurality of solar panels 130 can be couplable to a top surface of the modular housing 110 via a mount apparatus 132. The mount apparatus 132 can comprise a plurality of interconnected poles or support structures configured to support the weight of the plurality of solar panels 130 above the modular housing 110. The mount apparatus 132 may be manufactured from a strong material such as a metal sufficient to support large weights. Mount apparatus 132 may be couplable on one end to the top surface of modular housing 110, and couplable on another end to a bottom surface of the plurality of solar panels 130 or solar array.

Embodiments of the present disclosure advantageously can be stand alone and scalable, and can be relocated as desired or needed to a different rural or remote location. Once constructed, embodiments of the present disclosure require no additional engineering or access to a source of power. For example, system 100 can be constructed at an assembly plant in a city, transported to the intended location of use, and then immediately put into operation after completing pre-start operations. This is particularly useful in remote locations that experience frequent interruptions in access to electricity or standard fuel sources like gasoline, and also in locations where access to repair services is limited or unavailable.

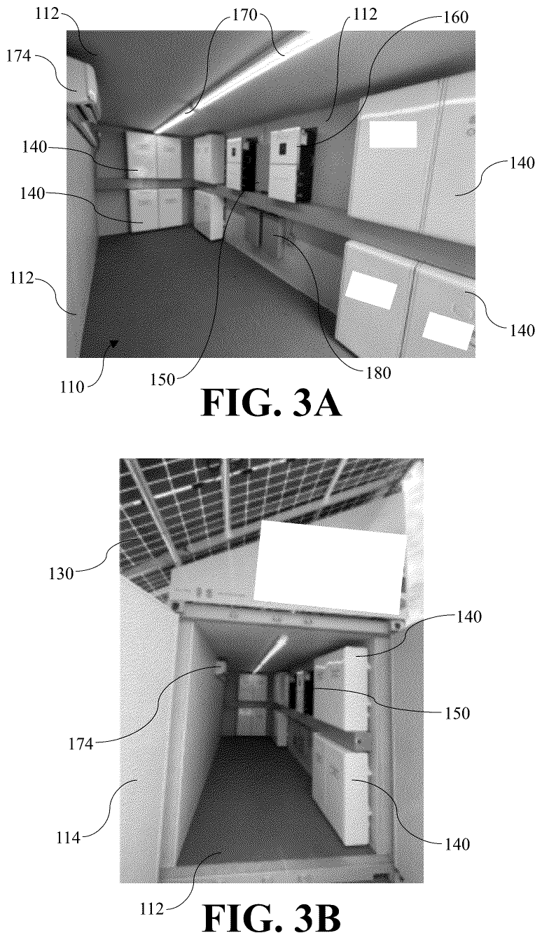

Referring now to FIGS. 3A and 3B, examples of the interior space or portion of modular housing 110 are illustrated, with several battery storage devices 140, a general load panel 150, two solar panel units 160, and two combiner panels 180 being depicted, among other components. Modular housing 110 is depicted in a rectangular configuration with several walls 112 connected to form an integral structure. Modular housing 110 includes an opening on one side where a pair of doors 114 are placed for access to the interior space. The battery storage devices 140 and other electrical components are conveniently placed around the perimeter of the interior space to allow a user to access the interior space for inspection and repairs, if necessary. Also depicted in FIGS. 3A and 3B are a pair of light sources 170 positioned on a top side of the interior space, and an HVAC unit 174 with a remote monitor positioned on a side wall opposite the battery storage devices 140 and other electrical components.

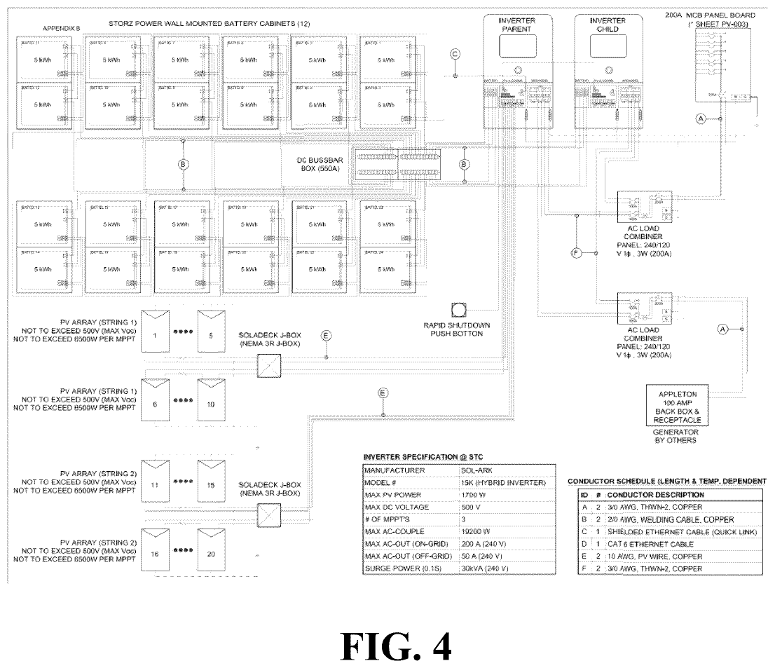

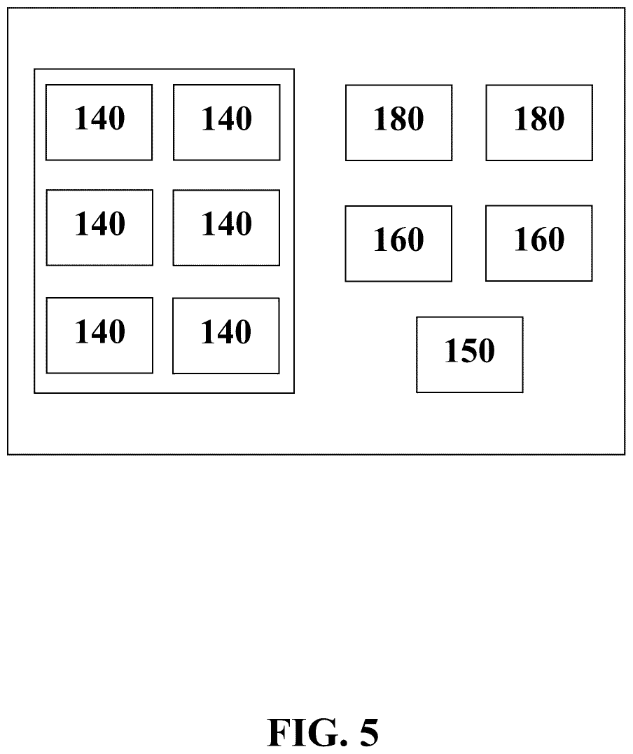

Referring now to FIG. 4, an electrical schematic used with system 100 illustrates electrical connections between various components. Referring now to FIG. 5, an example configuration of primary electrical equipment included with system 100 may comprise a plurality of battery storage devices 140, a general load panel 150, a pair of solar panel units 160, and a pair of combiner panels 180. The primary electrical equipment is generally positioned in the interior space or portion of modular housing 110 as described previously in reference to system 100. Other electrical equipment as described previously may also be positioned in the interior space or may be couplable to an exterior part of modular housing 110, as described previously and illustrated throughout the figures. In embodiments, system 100 may include smart grid technology and one or more Internet-of-things (IoT) devices to optimize energy usage, monitor performance, manage maintenance, or be remote controlled from a different location.

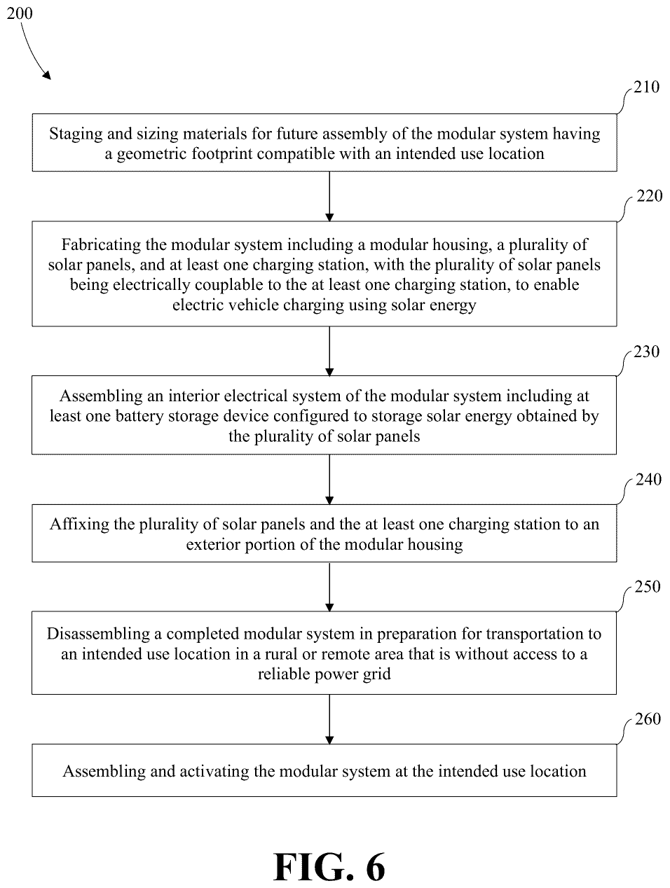

For an exemplary embodiment, a method of assembling a modular system for charging electric vehicles according to the present disclosure can comprise five phases. An embodiment of a method 200 of assembling a modular system for charging electric vehicles is illustrated in FIG. 6. In embodiments, the modular energy system illustrated in FIG. 6 may be equivalent to system 100 described previously.

Phase one 210 is the staging phase, in which the fabricators stage all required materials, with the materials cut or sized to the required length for a particular footprint. In phase 210, the following tasks are generally completed: setting up work stations; labeling materials with barcodes and scanning for available inventory; accumulating all materials for single unit in a common location; performing operations with a banding machine, taping materials, acquiring foam for modular housing wall protection; preparing various materials such as battery racks; cutting electrical wire package and labeling; cutting pipes to length; acquiring exterior lighting, if needed; cutting HVAC electrical lines to size; preparing one or more car bumper guards; preparing HVAC shelves, brackets, and covers; predrilling signage attachment locations for solar uprights; and preparing a rack for shipping materials in the interior space of modular housing.

Phase two 220 is modular energy system fabrication. The modular housing is preassembled, so all other elements are assembled around the preassembled modular housing. First, flooring is applied to the interior of the modular housing. In one embodiment, the flooring is an application of epoxy. Other types of flooring may be suitable. After the flooring has been applied, roof supports are welded to the modular housing and wall framing is fabricated along the interior portion of the modular housing. Insulation, blocking, plywood, and wall coverings are then applied to the framing. Lastly, the trim and door, supports for the solar panels, and paint are applied to the system.

Phase three 230 consists of assembling and placing the interior electrical system of the modular energy system. For example, the following tasks are generally completed in phase three 230: drilling holes for bracket placement; installing lower and top brackets for battery storage devices; positioning and assembling battery cabinets; installing charging station components on exterior of modular housing; installing inverters, panels, lights, solar panel units, and an HVAC platform; installing a conduit for an outside plug, HVAC unit, solar panel wiring, interior outlets, and Wi-Fi equipment for the remote Wi-Fi hot spot; mounting bus bars; installing battery storage devices; running wiring for battery, panel, lighting, HVAC unit, solar, generator plug, exterior outlet, and charging station applications; starting various electronics including lighting and the Wi-Fi hot spot; and cleaning up any debris or damage from phase three 230 assembly.

Phase four 240 consists of affixing the solar panels and the accompanying wiring to the modular system. The following tasks are generally performed in phase four 240: installing solar uprights with signage attachment locations predrilled; installing racking for solar panels; installing solar panels; wiring solar panels and plugging in to electrical connections; installing one or more charging stations; connecting the one or more charging stations to the solar panels; and setting up the dashboard which is connected to the plurality of solar panels.

Phase five 250 consists of preparing the system for shipment to its final destination. This phase may include removing certain components of the system for installation at the final destination, to ensure that no damage occurs during transport. For example, the solar panels, racking, piping, charging stations, and lighting may be removed prior to transport and reassembled with the modular energy system at its final destination. Method 200 provides an efficient and sustainable approach to assembling a modular system for charging electric vehicles in remote or rural areas that have no access or limited access to a reliable power grid. The assembled modular system provides a reliable approach to charging an electric vehicles in areas of the world where charging stations are not widely available. High quality assembly of a modular system according to the techniques of method 200 provides a reliable and long-lasting solution to electric vehicle charging in locations where access to charging would normally not be found or would not be feasible.

Embodiments of the present disclosure are also suitable generally for off-grid clean and renewable power generation rather than only electric vehicle charging. In particular, embodiments of the present disclosure are suitable for use in: residential settings for property owners who wish to reduce their energy bills and carbon footprint without high initial costs; commercial and industrial settings for businesses looking to lower operating costs and satisfy clean energy and sustainability goals; municipalities and public institutions such as schools, hospitals, and government buildings that wish to reduce energy expenses and promote clean energy initiatives; and remote and off-grid areas generally which have limited or unreliable access to traditional power grids (e.g., buildings located in rural areas may have little to no ability to generate continuous and reliable energy given their remoteness from a traditional power grid). Overall, embodiments of the present disclosure provide solutions to the increasing demand for renewable energy systems without requiring the high upfront costs typically associated with purchasing and installing such systems.

Various examples of systems, devices, and methods have been described herein. These examples are given only by way of example and are not intended to limit the scope of the claimed inventions. It should be appreciated, moreover, that the various features of the examples that have been described may be combined in various ways to produce numerous additional examples. Moreover, while various materials, dimensions, shapes, configurations and locations, etc. have been described for use with disclosed examples, others besides those disclosed may be utilized without exceeding the scope of this disclosure.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood by persons of ordinary skill in the art. Moreover, elements described with respect to one example can be implemented in other examples even when not described in such examples unless otherwise noted.

Although a dependent claim may refer in the claims to a specific combination with one or more other claims, other examples can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. A renewable, portable energy system for charging electric vehicles in rural areas that lack access to a traditional power supply, the system comprising:
a modular housing having an exterior portion and an interior portion;
at least one charging station coupled to the exterior portion of the modular housing, the at least one charging station configured to charge an electric vehicle;
a solar array comprising a plurality of solar panels configured to receive solar energy; and
at least one battery storage device positioned within the interior portion of the modular housing, wherein the at least one battery storage device is electrically coupled to the solar array and is configured to receive and store solar energy from the solar array, wherein the at least one battery storage device is electrically coupled to the at least one charging station and is configured to transfer the solar energy to the at least one charging station for use in charging an electric vehicle.

2. The system of claim 1, wherein the modular housing further comprises a plurality of walls connected to form a rectangular container.

3. The system of claim 1, wherein the modular housing further comprises at least one door separating the exterior portion from the interior portion.

4. The system of claim 1, further comprising at least one car bumper guard coupled to the exterior portion of the modular housing, the at least one car bumper guard configured to prevent parking vehicles from striking the exterior portion.

5. The system of claim 1, wherein the modular housing is insulated to create a temperature-controlled environment within the interior portion.

6. The system of claim 1, wherein the at least one battery storage device is coupled to a cabinet mounted within interior portion.

7. The system of claim 1, further comprising a mount apparatus coupled on one end to the modular housing and on another end to the solar array, the mount apparatus configured to support the solar array on top of the modular housing.

8. The system of claim 1, wherein the at least one charging station comprises an electric vehicle charger, a retractable charging cord coupled to the charger, and a charging holder for storing the charger and the charging cord when not in use.

9. The system of claim 1, further comprising a remote-controlled HVAC unit positioned within the interior portion of the modular housing.

10. The system of claim 1, wherein the modular housing, the at least one charging station, the solar array, and the at least one battery storage device are configured for uninterrupted, continuous use for long periods of time when assembled and put into operation in a rural area.

11. A renewable, portable energy system for charging electric vehicles in rural areas that lack access to a traditional power supply, the system comprising:
a modular housing having an exterior portion and an interior portion, the modular housing comprising a plurality of walls connected to form a rectangular container;
at least one charging station coupled to the exterior portion of the modular housing, the at least one charging station configured to charge an electric vehicle;
a solar array comprising a plurality of solar panels configured to receive solar energy, the solar array being coupled to the modular housing via a mount apparatus; and
at least one battery storage device positioned within the interior portion of the modular housing, wherein the at least one battery storage device is electrically coupled to the solar array and is configured to receive and store solar energy from the solar array, wherein the at least one battery storage device is electrically coupled to the at least one charging station and is configured to transfer the solar energy to the at least one charging station for use in charging an electric vehicle,
wherein the modular housing, the at least one charging station, the solar array, and the at least one battery storage device are configured for uninterrupted, continuous use for long periods of time when assembled and put into operation in a rural area.

12. The system of claim 11, wherein the modular housing further comprises at least one door separating the exterior portion from the interior portion, the at least one door being coupled to the modular housing via a hinge.

13. The system of claim 11, further comprising at least one car bumper guard coupled to the exterior portion of the modular housing, the at least one car bumper guard configured to prevent parking vehicles from striking the exterior portion, wherein the car bumper guard defines a semi-circle shape, such that the end points of the semi-circle are affixed to the exterior portion of the modular housing.

14. The system of claim 11, wherein the modular housing is insulated to create a temperature-controlled environment within the interior portion, such that the interior portion is insulated from harsh external weather conditions at the rural area.

15. The system of claim 11, wherein the at least one battery storage device is coupled to a cabinet mounted to the interior portion.

16. The system of claim 1, wherein the at least one charging station comprises an electric vehicle charger, a retractable charging cord coupled to the charger, and a charging holder for storing the charger and the charging cord when not in use.

17. The system of claim 1, further comprising a remote-controlled HVAC unit positioned within the interior portion of the modular housing, the HVAC unit configured to maintain a temperature-controlled environment within the interior portion to preserve operation of the at least one battery storage device.

18. The system of claim 1, further comprising at least one Internet-of-things device communicatively coupled to a remote device external to the system.

19. The system of claim 1, further comprising one or more of a general load panel, a solar panel control unit, and a combiner panel positioned within the interior portion of the modular housing.

20. A method of assembling a renewable, modular energy system for use in rural areas that lack access to a traditional power supply, the method comprising:
staging and sizing materials for future assembly of the modular energy system having a geometric footprint compatible with an intended use location in a rural area lacking access to a reliable power grid;
fabricating the modular energy system comprising a modular housing, a solar array having a plurality of solar panels, and at least one charging station, wherein the solar array is electrically coupled to the at least one charging station to enable electric vehicle charging using solar energy;
assembling an interior electrical system of the modular energy system including at least one battery storage device configured to storage solar energy obtained by the solar array;
affixing the solar array and the at least one charging station to an exterior portion of the modular housing;
disassembling a completed modular energy system in preparation for transportation to the intended use location; and
assembling and activating the modular energy system at the intended use location.
